(19) United States
(12) Patent Application Publication
(10) Pub. No.: US 2004/0044594 A1
(43) Pub. Date: Mar. 4, 2004

(54) System for, and method of, providing information from a second party to a first party relating to inventory

(76) Inventor: Louis Angerame, Fairfield, CT (US)

Correspondence Address: ELLSWORTH R. ROSTON, HOWARD HUGHES CENTER, 6060 CENTER DRIVE, TENTH FLOOR, LOS ANGELES, CA, 90045, US

(21) Appl. No.: 10/229,503

(22) Filed: Aug. 28, 2002

(51) Int. Cl. G06F 17/60

(52) U.S. Cl. 705/28

(57) ABSTRACT

Information at a second party relates to inventory of products sold to a first party. The first party programs a databot at the second party, in accordance with rules established by the first party, to have the second party specify to the first party at particular dates and times the inventories at the second party for each of the products. In accordance with this programming, the second party provides to the first party at the particular times through a databot the information relating to the inventories of the products at the second party. Each party provides to the databot at the other party information relating to one product in a sequence while receiving information from a database relating to a next product in the sequence. Each party continues to activate its databot to receive information from the associated database when the database is activated.

This invention relates to systems for, and methods of, providing information from a vendor to a customer (a wholesaler or retailer) relating to inventory of a product at the vendor or at the vendor's customer. In one embodiment, the vendor provides an indication of the inventory of the product at the vendor when the customer has a low inventory of the product and the customer seeks to obtain the product from the vendor's inventory. In another embodiment, the vendor seeks to determine the customer's inventory of the product so that the vendor can replenish the customer's inventory when the customer's inventory is low. The invention has application to various types of transaction data, only one of which is inventory of a product or products.

The invention particularly relates to improvements in systems and methods disclosed and claimed in a patent application (attorneys file GCOMM-61556) filed by Louis Angergame in the United States Patent and Trademark Office on or about Aug. 15, 2002 for SYSTEMS FOR, AND METHODS OF, PROVIDING INFORMATION FROM A VENDOR TO A CUSTOMER RELATING TO INVENTORY and assigned of record to the assignee of record of this application.

### BACKGROUND OF THE PREFERRED EMBODIMENTS OF THE INVENTION

For decades, vendors and their customers (wholesalers and retailers) have attempted to establish relationships where the wholesalers and retailers retain a minimal inventory of a product and where the vendor instantly replenishes the customer's inventory of the product when the customer's inventory of the product becomes low. For example, Japanese car makers have used this technique for years with their parts suppliers to reduce their costs in manufacturing and selling motor vehicles. This technique has been characterized in the press as “just in time”. “Just in time” has insured that car manufacturers will receive inventory of parts in time to maintain a steady rate of car production.

Although much progress has been made in refining these techniques, these techniques are still relatively crude in comparison to what experts in the field foresee for the future. This is particularly true since the creation of the internet. This results from the fact that the internet provides for instantaneous communication between the vendor and the vendor's customer. This instantaneous communication is available even though the vendor and the vendor's customer may be physically separated from each other by great distances. Furthermore, communication through the internet between the vendor and the vendor's customer can be established through the internet on a minimal cost basis.

In recent years, a number of companies have been established to provide communications through the internet between a vendor and a vendor's customer concerning inventory of a product. These communications have been provided in an attempt to maintain a continuing, but low, supply of a vendor's product at the vendor's customer. The vendor's customer may be a wholesaler or retailer which in turn resells the vendor's products to customers of the wholesaler or retailer.

The companies established in recent years have been designated as ‘business-to-business (or “b to b”). Considerable hype has been provided in the press concerning the importance of these companies in enhancing the efficiency of business operations. The enhancement in efficiency has been shown with the passage of time to be illusory. The different techniques provided by these companies have been shown with the passage of time to be crude and even flawed. Many of these companies are now either out of business or have been reduced substantially in size and financial resources so that they are no longer effective. In spite of this, the need still exists, perhaps now more than ever, to provide a simple, operative and efficient system for, and method of, maintaining an effective, but lean, supply of a vendor's product at the vendor's customers.

In co-pending application Ser. No. 10/219,098 (attorneys file GCOMM-61556), systems and methods are disclosed and claimed for providing information at a second party relating to its inventory of products. A first party programs a databot at the second party, in accordance with rules established by the first party, to have the second party specify to the first party at particular dates and times the inventories of the individual ones of the different products supplied by the second party to the first party. In accordance with this programming, the second party provides to the first party at the particular times the information relating to the inventories of the different products at the second party. The first party may be a vendor or a customer (wholesaler or retailer) of the vendor and the second party may be the other one of the vendor or the vendor's customer. Thus, the vendor can continuously maintain the inventory of the product at the vendor's customer at a lean but efficient level.

### BRIEF DESCRIPTION OF PREFERRED EMBODIMENTS OF THE INVENTION

Information at a second party relates to inventory of products sold to a first party. The first party programs a databot at the second party, in accordance with rules established by the first party, to have the second party specify to the first party at particular dates and times the inventories at the second party for each of the products. In accordance with this programming, the second party provides to the first party at the particular times through a databot the information relating to the inventories of the products at the second party. Each party provides to the databot at the other party information relating to one product in a sequence while receiving information from a database relating to a next product in the sequence. Each party continues to activate its databot to receive information from the associated database when the database is activated.

### BRIEF DESCRIPTION OF THE DRAWINGS

In the drawings:

FIG. 1 is a schematic diagram of a system disclosed in co-pending application Ser. No. 10/219,098 (attorneys file GCOMM-61556) and providing for a vendor's customer (wholesaler or retailer) to inquire of the vendor concerning the inventory of a product at the vendor when the vendor's customer has a low inventory of the product;

FIG. 2 is a schematic diagram of the embodiment shown in FIG. 1 and shows the embodiment in additional detail;

FIGS. 3 and 3a are schematic diagrams of the embodiment shown in FIGS. 1 and 2 and show the operation of the vendor on an intranet basis and the communication between the vendor and the vendor's customer on an internet basis;

FIGS. 4 and 5 constitute a composite flow chart showing a prior art procedure in which a vendor's customer receives an inquiry from a user concerning the availability of a product and in which the vendor's customer obtains this information from the vendor;

FIG. 6 is a flow chart which is included in the embodiment shown in FIGS. 1, 2, 3 and 3a and in which the embodiment performs functions on a simpler and more efficient basis than the prior art;

FIG. 7 is a flow chart showing a prior art procedure for checking the status of an unfilled order previously made by a user to a vendor's customer;

FIG. 8 constitutes a flow chart included in the embodiment shown in FIGS. 1, 2, 3, 3a and 5 for performing functions on a simpler and more efficient basis than the prior art shown in FIG. 7;

FIGS. 9 and 10 constitute a composite flow chart showing a prior art procedure for the placing of an order by a customer;

FIG. 11 is a flow chart showing the procedure of the embodiment shown in the previous Figures for the placing of an order by a customer;

FIG. 12 is a flow chart showing a prior art system for obtaining the tracking of an order previously placed by a customer;

FIG. 13 is a flow chart showing in additional detail the system and method shown in individual ones of the previous Figures for obtaining the tracking of an order previously placed by a customer;

FIG. 14 is a flow chart showing in additional detail how the system and method shown in individual ones of the previous Figures progressively focus at the vendor's facility on the location of information relating to the inventory of a product ordered by a customer so as to determine the inventory of the product at the vendor's facility;

FIGS. 15 and 16 constitute a composite flow chart showing in further detail how the system and method shown in individual ones of the previous Figures progressively focus at the vendor's facility on the location of information relating to the inventory of the product ordered by a customer so as to determine the inventory of the product at the vendor's facility;

FIGS. 17 and 18 constitute a composite flow chart operative in conjunction with individual ones of the previous Figures and showing how the vendor determines the inventory of the product at the vendor's facilities and transmits this information to the facilities of the vendor's customer;

FIG. 19 constitute a flow chart operative in conjunction with individual ones of the previous Figures and showing in additional detail how the vendor determines the inventory of the product at the vendor's facility of the product ordered at the facility of the vendor's customer and transmits the information to the facility of the vendor's customer;

FIG. 20 is a flow chart operative in conjunction with individual ones of the previous FIG. 1 and showing how the vendor determines the times for the transmission to the vendor's customer of the information relating to the inventory of the product at the vendor's facility;

FIG. 21 is a flow chart operative in conjunction with individual ones of the previous Figures and showing how the vendor's customer determines the times for the vendor to provide information relating to inventories of individual ones of different products being purchased by the customer from the vendor;

FIG. 22 is a flow chart operative in conjunction with individual ones of the previous Figures and indicating how the vendor progressively focuses on the information relating to the inventories of the vendor with respect to individual ones of the products being purchased by the vendor's customer from the vendor;

FIGS. 23 and 24 constitute composite flow charts which are operative in conjunction with individual ones of the previous Figures and which show how the vendor (1) selects information relating to the inventory of an individual one of the products, (2) transfers this information to the vendor's customer, and (3) the vendor's customer uses this information;

FIG. 25 is a flow chart showing the operation of another embodiment of the system disclosed and claimed in co-pending application Ser. No. 10/219,098 (attorneys file GCOMM-61556), the vendor operating in this embodiment to obtain information concerning the inventory of individual products at the vendor's customer so as to make certain that the vendor's customer has a sufficient inventory of these individual products to satisfy any reasonable demand for these products at the vendor's customer;

FIG. 26 provides simplified flow charts showing how each party provides to the database at the other party information relating to one product in a sequence while receiving information from a database relating to a next product in the sequence;

FIG. 27 is a simplified flow chart showing how each party continues to activate its databot so that the databot is ready to receive information from the associated database when the database is activated;

FIG. 28 is a flow chart showing how a spreadsheet such as an Excel spreadsheet can be substituted in place of a database at the vendor's customer to transmit rules to the vendor relating to the dates and times for the vendor to submit to the vendor's customer the inventory of the vendor for the different products sold by the vendor to the vendor's customer; and

FIG. 29 is a block diagram further showing the construction and operation of a spreadsheet system providing for the operation in accordance with the flow chart shown in FIG. 28.

### DETAILED DESCRIPTION OF PREFERRED EMBODIMENTS OF THE INVENTION

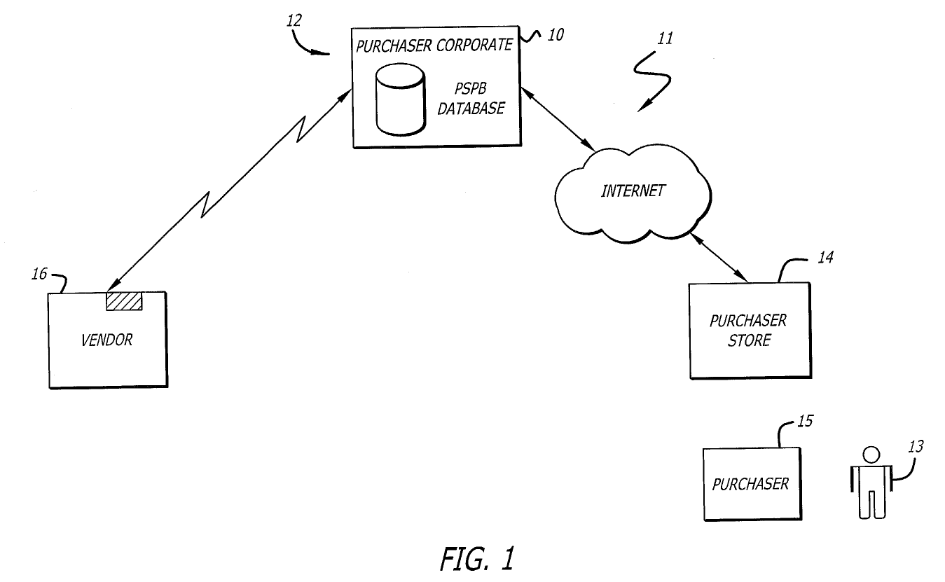

FIG. 1 is a schematic diagram illustrating the operation of a preferred embodiment, generally indicated at 11, of an invention disclosed and claimed in co-pending application Ser. No. 10/219,098 (attorneys file GCOMM-61556). In this preferred embodiment, the corporate offices 10 of a purchaser, generally indicated at 12, constituting a retailer or wholesaler, lists the inventory of different products which the company sells. The different products may be in a particular field, such as vehicle components for replacing worn or defective components in vehicles. Alternatively, the different products may be in a number of different lines as dissimilar as those carried by Wal-Mart. The purchaser 12 may have a number of different selling locations, one of which is illustrated at 14. The number of different selling locations of the company 12 may be quite large such as, for example, the number of stores in the Wal-Mart organization or may be any amount smaller than the number of stores in the Wal-Mart organization.

A customer 13 may approach the store 14 and tell the customer's service representative (e.g. sales clerk) 15 at the store that he wants to buy an alternator for a 1996 Buick LeSabre. The sales clerk may then see if the alternator is in stock at the store. If the alternator is not in the inventory at the store, the sales clerk 15 may inquire through the intranet or internet to determine from the corporate offices 10 if a unit of the alternator is available at the corporate offices or at another store in the corporate organization. If a unit of the alternator is available at the corporate offices 10 or at another store in the corporate organization, the corporate offices will notify the store 14 of the availability of the unit and will ship, or have shipped, the alternator unit to the store.

It may be that an alternator unit is not available at the corporate offices 10 or at any of the company's stores such as the store 14. This invention provides for the corporate office 10 of the purchaser 12 to determine at specified times the inventory that a vendor 16 (the supplier of the alternator to the company 12) has of the alternator. These times for the vendor 16 to communicate with the purchaser 12 are specified by the corporate office 10 of the purchaser 12 to the vendor 16. At the specified times, the vendor 16 transmits to the corporate office 10 of the purchaser 12 through the internet the inventory of the alternator that the vendor can supply immediately to the purchaser. In this way, the corporate office 10 of the purchaser 12 is able to obtain from the vendor 16 an inventory of the alternator at the vendor on an immediate basis when the store 14 has run short of units of the alternator. The corporate office 10 of the purchaser 12 promptly relays this information to the store 14 where the customer 13 is located. This helps the customer 13 to maintain good relations with its customers.

It will be appreciated that the inventory of the vendor 16 at the purchaser 12 may relate to a plurality of items only one of which may be the alternator. It will be further appreciated that the vendor may have a plurality of inventory stations and that the inventory information provided by the vendor 16 to the corporate office 10 of the purchaser 12 may be an accumulation of the inventory at all of the different vendor stations. Furthermore, applicant's invention has broader utility than the indication of inventory without departing from the scope of the invention. For example, the information transferred from the vendor 16 may relate to transaction data of all different types and may involve different types of information than inventory.

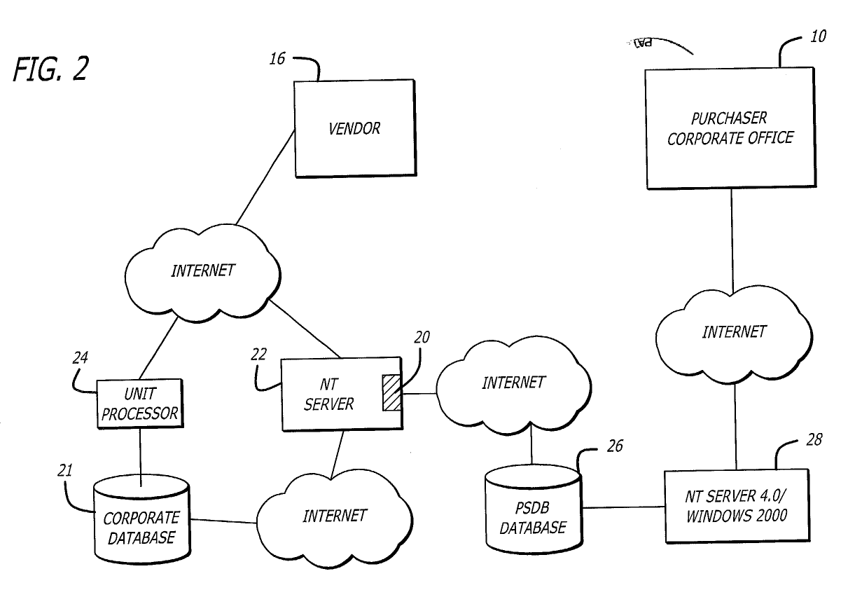

FIG. 2 provides additional information concerning the communication between the purchaser 14 and the vendor 16 concerning the inventory of the alternator at the vendor. As shown in FIG. 1, the corporate office 10 communicates with the vendor 16 by transmitting rules to the vendor for the times of the transfer of specific inventory information at the vendor to the corporate office 10. The rules may be transmitted by the purchaser's corporate office 10 to a databot 20 in a server 22 at the vendor.

The databot 20 may be considered to constitute a database at the vendor 16 for converting the rules from the purchaser's corporate office 10 to a form which is transmitted through the intranet to a corporate data base 21 at the vendor. The data base 22 and a unit processor 24 then operate in accordance with these rules to determine the inventory of the alternator at the vendor. This information is then transmitted through the intranet to the server 22 at the vendor 16 which conveys this information through the internet to a power site data base 26 at the purchaser's corporate office 10. The data base (PSDB) 26 transfers this information to a server 28 which in turn conveys this information through the internet to the purchaser's corporate office 10. Although this transfer of information has been described in this paragraph for the alternator, it will be appreciated that the same discussion applies to all of the other products which the vendor 16 supplies to the purchaser 12.

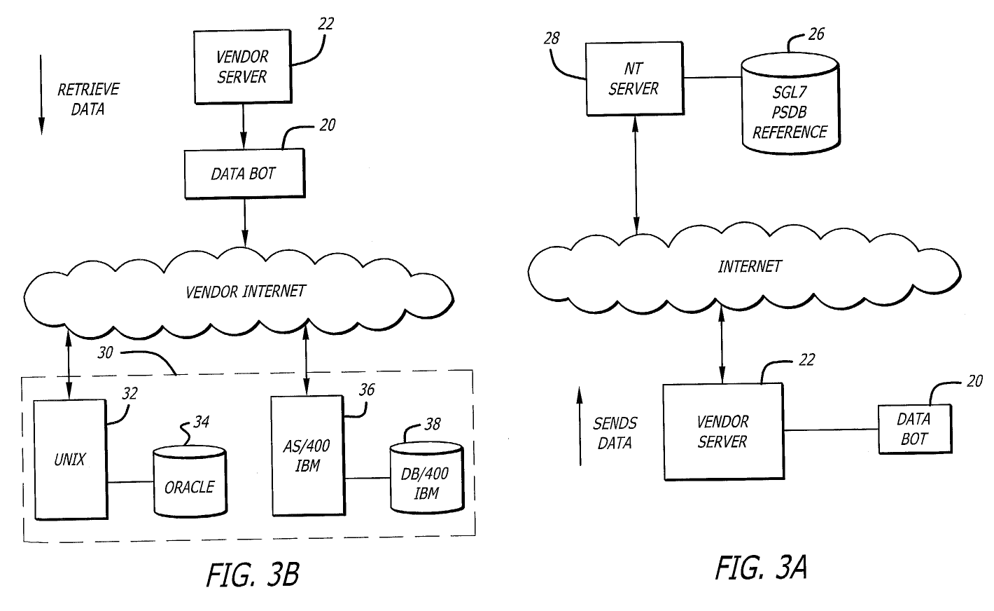

FIG. 3a is a flow chart of the system and method disclosed and claimed in co-pending application Ser. No. 10/219,098 (attorneys file GCOMM-61556) and shows the transactions between the purchaser's corporate office 10 and the vendor 16 through the internet. FIG. 3a includes the power site 26 and the server 28 at the purchaser's corporate office 10. FIG. 3a also includes the databot 20 and the server 22 at the vendors 16. FIG. 3b shows the databot 20 and the server 22 at the vendor 16. FIG. 3b also shows how the databot 20 communicates through the intranet with various processing equipment at various warehouses of the vendor such as a warehouse indicated in broken lines at 30. This processing equipment may include a Unix processor 32, Oracle equipment 34 and IBM equipment such as the IBN AS/400 equipment 36 and DB1400 equipment 38. It will be appreciated that the Unix, Oracle and IBM equipments are only exemplary of the equipments that can be provided. The Unix, Oracle and IBM equipments operate to determine the inventory of various items at the vendor's warehouses.

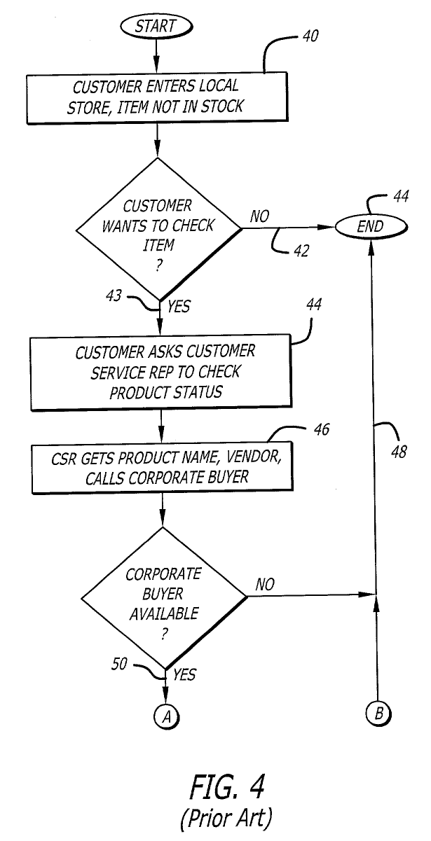

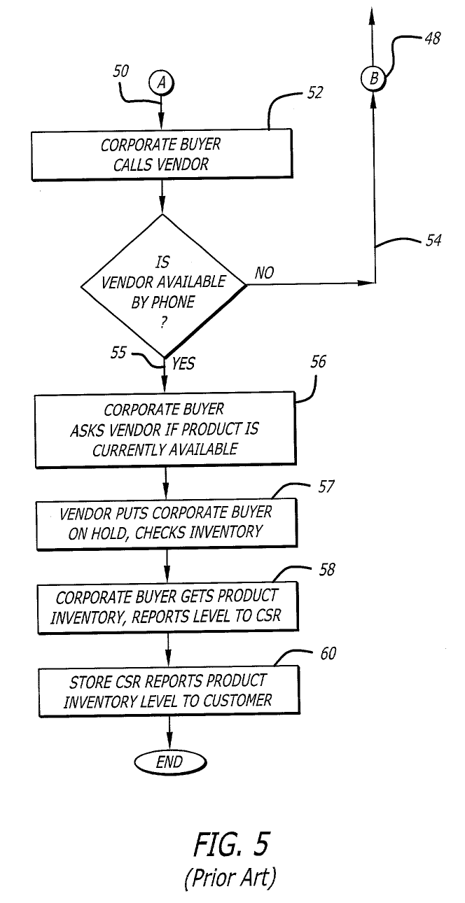

FIGS. 4 and 5 are flow charts showing how systems of the prior art operate to determine whether a vendor has units of a product such as an alternator when a customer needs the alternator and the purchaser's corporate office and the branch offices of the purchaser do not have the alternator in stock. As a first step indicated at 40, the customer 13 (e.g., 14 in FIG. 1) enters a branch store of the purchaser and attempts to purchase a unit of the alternator. As indicated at 40, the customer learns from the purchaser's sales clerk 15 that the alternator is not in stock at the branch 14 of the purchaser. If the customer 13 does not wish to push the matter further (see “No” at 42), the matter relating to the purchase of the alternator by the vendor is ended. This is indicated at 44 in FIG. 4.

If the customer 13 desires to obtain additional information about the status of his order to obtain the alternator, the customer answers affirmatively at 43. The customer then asks the customer service representative 15 to check the status of the alternator (see 44). The customer service representative 15 then obtains the product name and the vendor's name and telephones the purchaser's buyer (see 46 in FIG. 4). If the corporate buyer is not available, this is the end of the status check at this time. This is indicated at 48 In FIG. 4. If the corporate buyer is available as indicated at 50 in FIGS. 4 and 5, the corporate buyer calls the vendor as indicated at 52. If the vendor is not available (see 54 in FIG. 5), this is the end of the inquiry check at this time. This results from the interconnection between the line 48 in FIG. 5 and the line 48 in FIG. 4.

If the vendor is available at this time as indicated at 55 in FIG. 5, the corporate buyer asks the vendor if the alternator is currently available. This is indicated at 56. The vendor then puts the corporate buyer on hold and checks the inventory of the alternator at the vendor (see 57). When the corporate buyer obtains information concerning the level of the alternator inventory at the vendor, he reports this to the customer service representative. This is indicated at 58. The customer service representative then reports this inventory to the customer (see 60).

As will be seen from FIGS. 4 and 5 and the discussion above concerning FIGS. 4 and 5, the process represented by the flow chart is slow and inefficient. The customer relies on phone calls to be made by the customer service representative to the corporate buyer, and then by the corporate buyer to the vendor, with the distinct possibility that either the corporate buyer or the vendor is not available. When the corporate buyer or the vendor is not available, the process shown in FIGS. 4 and 5 has to be repeated from the beginning of FIG. 4. Furthermore, phone calls are not an efficient mode of communication even if the process is consummated from the beginning of the flow chart in FIG. 4 to the end of the flow chart in FIG. 5.

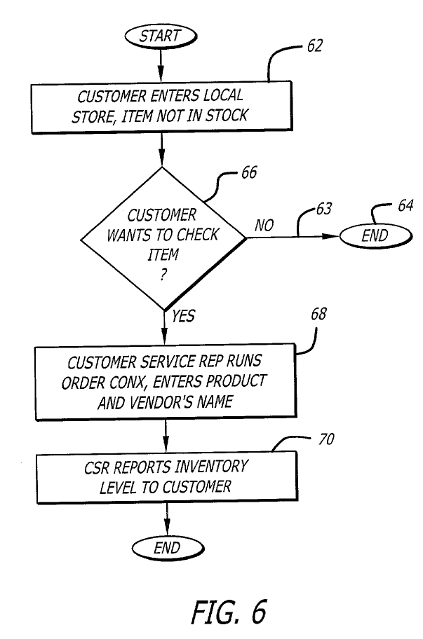

FIG. 6 is a flow chart of the system and method disclosed and claimed in co-pending application Ser. No. 10/219,098 (attorneys file GCOMM-61556) for checking the availability of inventory to satisfy an order made by the customer 13 to a customer service representative 15 at the purchaser's branch store 14. As a first step indicated at 62, the customer 13 enters the purchaser's branch store 14 and asks the customer's service representative 15 to check if the unit of the alternator is available. The customer's service representative then indicates that the unit is not available at the store. This is indicated at 62 in FIG. 6. If the customer indicates that he does not want any further check to be made, no further work is performed as indicated at 64 in FIG. 6.

If the customer wants to make further checks of the order see (see 66), the representative first checks with the purchaser's corporate office 10 to determine from the office 10 if a unit of the order is available at the office or at one of the other selling offices of the purchaser. If the purchaser 14 has a unit of the alternator at its corporate office or at one of its selling offices, the purchaser arranges to have the unit of the alternator delivered to the customer. All of the acts specified in this paragraph may be considered to be included within a block 68.

If the purchaser 14 does not have a unit of the alternator at one of its facilities, the purchaser determines from its records if the vendor has a unit of the alternator in its inventory. This step may also be considered to be included within the block 68 in FIG. 6. The purchaser does not have to make a determination at this time because the purchaser periodically receives from the vendor 16 an indication of the inventory of the alternator at the vendor. The indication of the inventory of the alternator at the vendor has been previously determined by the vendor in accordance with the rules established by the purchaser 14 and has been transmitted to the purchaser by the vendor at the time of the determination by the vendor. Thus, a fresh determination of the inventory of the alternator at the vendor is always available to the purchaser corporate office 10. This determination of the inventory availability is indicated to customers as shown at 70 in FIG. 6. The purchaser 14 then orders a unit of the alternator from the inventory at the vendor and delivers this unit to the customer 13 when the purchaser receives the unit from the vendor, assuming that the vendor 16 has inventory of the alternator at that time.

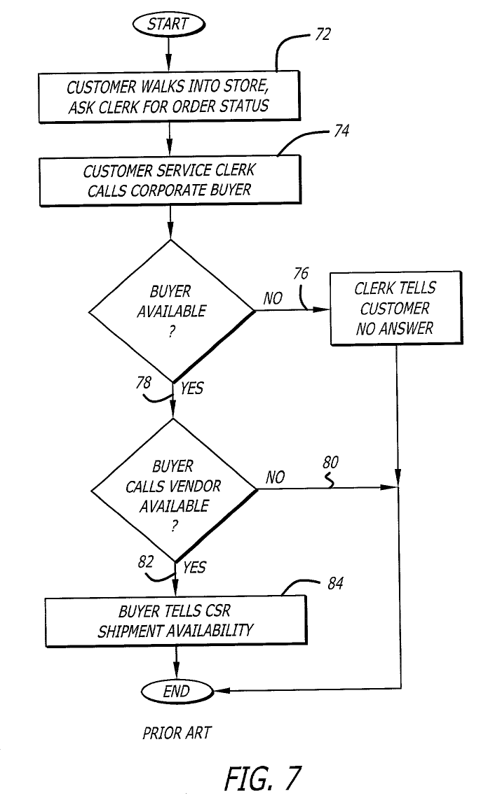

FIG. 7 is a flow chart showing a prior art system for, and method of, checking the status of an order such as the order of the customer 13 for the unit of the alternator. As a first step 72 in the flow chart, the customer 13 walks into the purchaser's store 14 and asks the customer service representative to check the status of the order. The customer service representative then calls the purchaser's buyer (see 74). If the buyer is not available, the store clerk 15 tells the customer 13 of the buyer's unavailability and this is the end of the procedure. If the buyer is available (78), the buyer calls the vendor as indicated at 80. If the vendor is not available (see 82), this is the end of the sequence. If the vendor is available (82), the vendor indicates the status of the order to the buyer and the buyer tells this information to the customer service representative. This is indicated at 84 in FIG. 7. As will be seen, this procedure is slow and complicated and can be interrupted at several instants because of the unavailability of personnel.

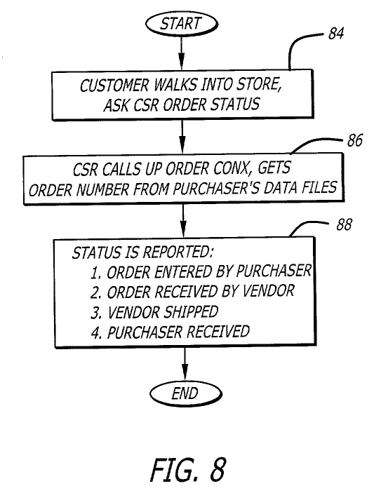

FIG. 8 is a flow chart showing the system and method disclosed and claimed in co-pending application Ser. No. 10/219,098 (attorneys file GCOMM-61556) for checking the status of an order. As a first step 86, the customer 13 walks into the purchaser's store 14 and, as indicated at 84, asks the purchaser's customer service representative 15 for the status of his order for the alternator. The customer service representative then obtains the customer's order number from the purchaser's data files. The customer service representative also obtains the status of the order from the purchaser's data files. This information includes the following: (1) the entry of this order by the purchaser, (2) the receipt of the order by the vendor, (3) the shipment of the alternator by the vendor to the purchaser to fulfill the order and (4) the receipt of the alternator by the purchaser. The status report is indicated at 88 in FIG. 8.

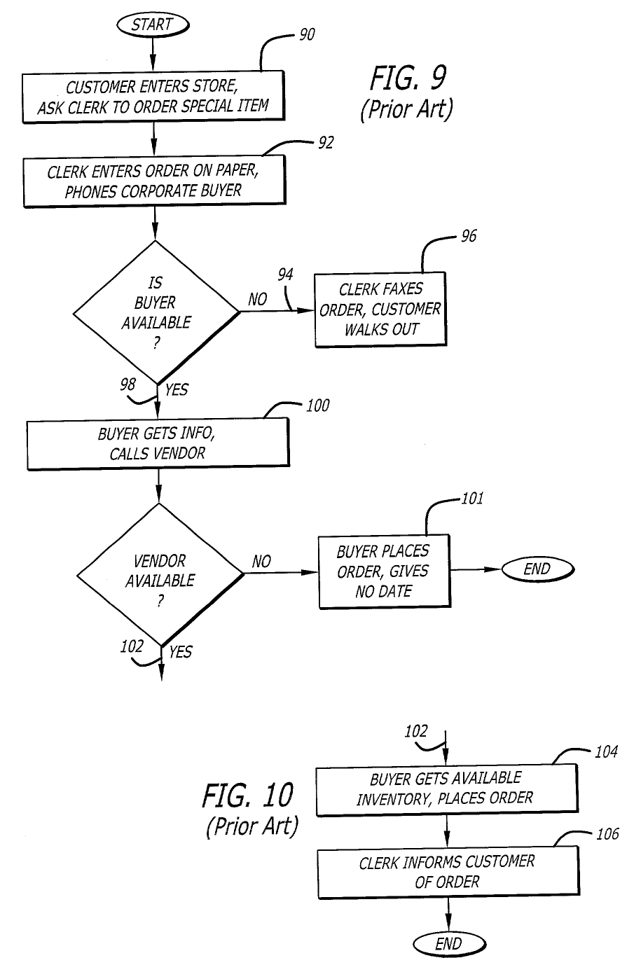

FIGS. 9 and 10 are flow charts of a prior art system for, and method, of tracking an order previously placed by the customer 13 to the customer's service representative 15 at the purchaser 14. The prior art system includes the step 90 relating to the entrance by the customer into the purchaser's store and the order by the customer of the alternator. The customer's service representative enters the order on an order form and phones the corporate buyer to place the order if the alternator is not available at the purchaser's store 14. That is indicated at 92. If the buyer is not available as indicated at 94, the customer's service representative sends a facsimile to the order to the buyer as indicated at 96 and the customer departs.

If the buyer is available (see 98), the buyer obtains the information to identify the order and calls the vendor if the purchaser 14 cannot fill the order from its inventory. This is indicated at 100. If the vendor is not available, the buyer places the order by facsimile and gives no date to the customer's service representative as to when the order will be filled by the vendor. This is indicated at 101. This constitutes the end of the flow chart under such circumstance. If the vendor is available (102 in FIGS. 9 and 10), the buyer determines the inventory of the order at the vendor and places the order as indicated at 104 in FIG. 10. The customer's service representative 15 then indicates to the customer 13 that the order has been placed. See 106 in FIG. 10.

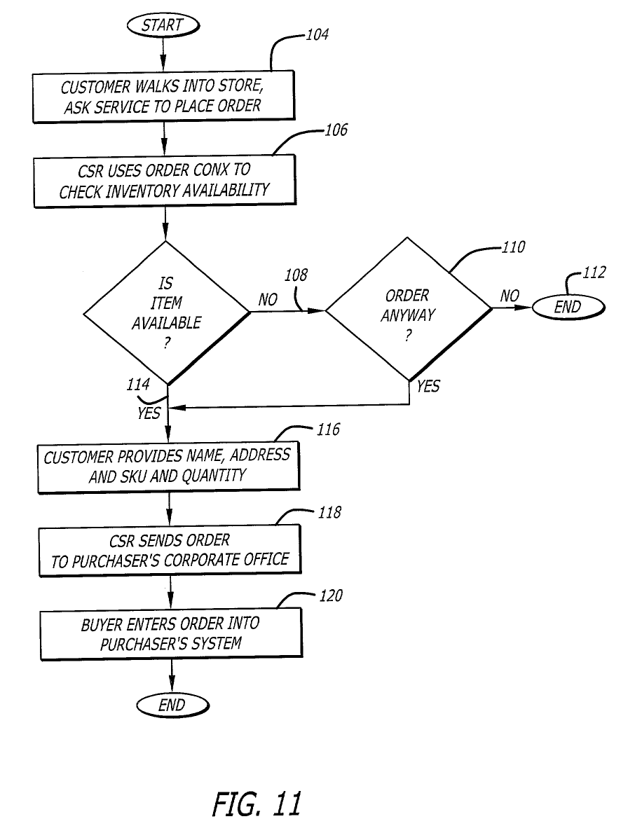

FIG. 11 is a flow chart showing how an order is placed and processed by the system and method disclosed and claimed in co-pending application Ser. No. 10/219,098 (attorneys file GCOMM-61556). As a first step as indicated at 104, a customer walks into one of the purchaser's branch store 14 and places an order. The representative then uses the system of this invention to check the inventory available as indicated at the purchaser's corporate office 10. This checking is indicated at 106 in FIG. 11. If the inventory is not available from the indications at the purchaser's corporate office 10 (see 108), or at the branch stores such as the branch store 14, the customer may wish to place the order anyway. See 110 in FIG. 11. If the customer does not wish to place the order, this is the end 112 of the sequence.

If the inventory is available at the purchaser's corporate office 10 or at the branch stores (see 10), information for placing the order is provided by the customer and the service representative. This may include the name, address and telephone number of the customer, the quantity of the item (e.g. the alternator) being ordered, and the stock keeping unit of the item at the purchaser's corporate office 10. This is indicated at 116. The customer service representative then sends the order, and the information relating to the order, to the purchaser's corporate offices. This is indicated at 118. The purchaser's corporate office 10 then enters the order into its system as indicated at 120.

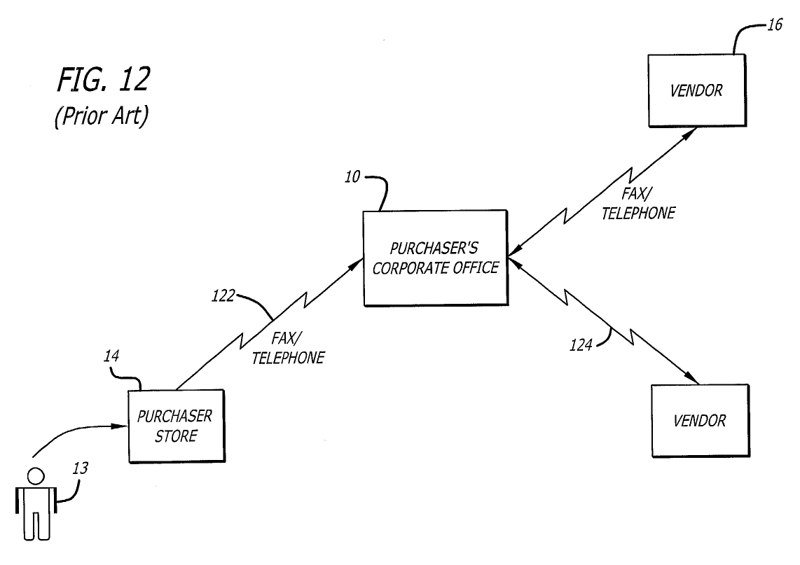

FIG. 12 is a flow chart of a prior art system for tracking an order. The customer enters a branch store 14 of the purchaser 12 to inquire as to the status of a previously placed order. The branch store 14 telephones or faxes the purchaser's corporate office 10 (see 122) to make this inquiry. The corporate office 10 then telephones or faxes the vendor 16 (see 124) to make this inquiry. This is a lengthy and cumbersome procedure with a good chance that the transaction will not be completed because of unavailability of personnel. Furthermore, the process is slow and inefficient.

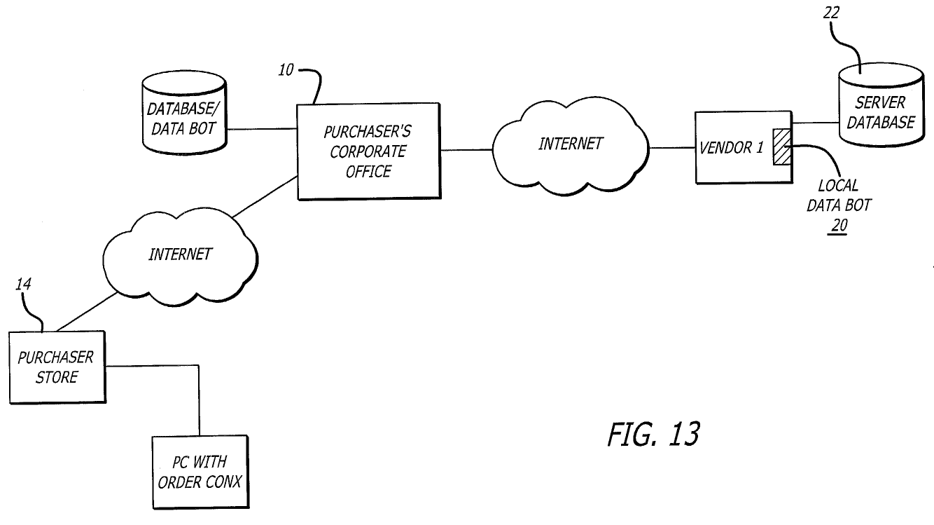

FIG. 13 is a flow chart showing how the system disclosed and claimed in co-pending application Ser. No. 10/219,098 (attorneys file GCOMM-61556) operates to track an order. The customer 13 enters into the purchaser's store 14 to track the order. The store communicates through the internet with the power site database 26 at the purchaser's corporate office 10. The purchaser's corporate office 10 then communicates through the internet with the databot 20 which obtains the information from the database at the server 22. This information is then transferred through the internet to the purchaser's corporate office 10 and then through the internet to the purchaser's store 14. In this way, the customer 13 is advised as to the status of his order for the alternator.

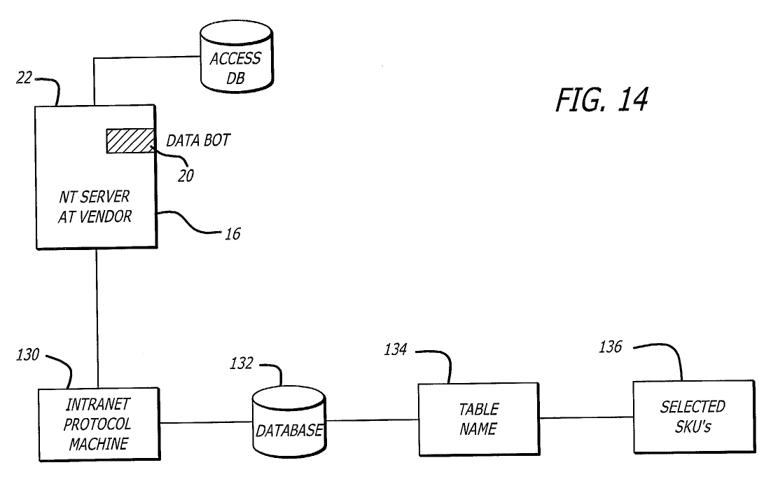

FIG. 14 is a flow chart of the system and method disclosed and claimed in co-pending application Ser. No. 10/219,098 (attorneys file GCOMM-61556) and indicates how the vendor 16 is set up to provide information to the purchaser 14 concerning the inventory of a particular order such as the alternator. The server 22 at the vendor 16 obtains this information at the databot 20 through the intranet from an internet protocol machine 130 at the vendor 16. The vendor 16 then selects the type of database (e.g. Oracle) 132 being used and then selects table or the portion 134 of the database where the data related to the inventory of the alternator is located. If the database is secure, the vendor may have to specify the table or portion 134 and give a predetermined password to enter the portion or table of the server 22 where the information relating to the inventory of the alternator is located. As a final step, the vendor selects the rows 136 where the information relating to the inventory of the alternator is located. As will be seen, the vendor 16 progressively focuses in on the location of the inventory of the alternator in the vendor's database.

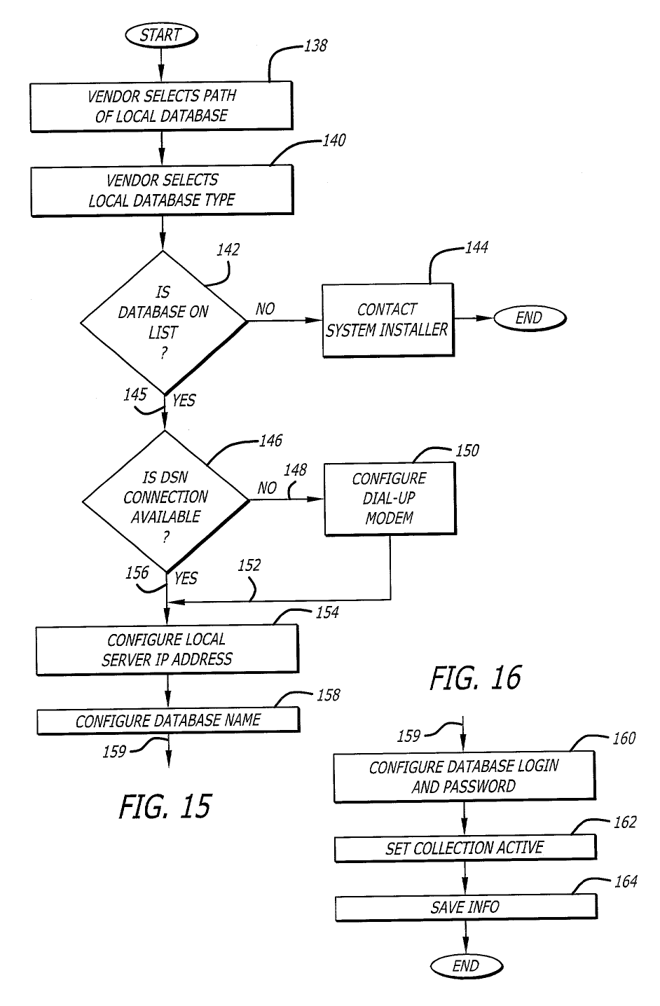

FIGS. 15 and 16 constitute a composite flow chart of the steps taken by the vendor 16 in the system and method disclosed and claimed in co-pending application Ser. No. 10/219,098 (attorneys file GCOMM-61556) to accomplish the steps shown in FIG. 14 and specified in the previous paragraph. As a first step as indicated at 138, the vendor 16 selects the path of the local (or vendor's) database. In other words, the vendor 16 accesses the database in the personal computer or server 22 where the databot is operating. The vendor 16 then selects the local database type (e.g. Oracle). (See 140 in FIG. 16.) The vendor 16 then determines whether the selected database is on the vendor's list (see 138) which lists the local databases that can be accessed. If the selected database is not on this list, the vendor 16 contacts the company which has installed the system to have the system on the vendor's list (see 144). In this way, the vendor 16 can be connected to the selected database even though the selected data base is not on the vendor's list. This is the end 195 of the sequence where the selected database is not on the vendor's list.

If the selected data base is on the vendor's (145) list, a determination (146) is made as to whether a valid dynamic server name (DSN) connection is available. If the answer is “no” as indicated at 148, a dial-up modem (see 150) is configured or dialed. If this is done as indicated at 152, the vendor's internet protocol address is dialed or configured (see 154) to obtain the vendor's server 22 as indicated at 130 in FIG. 14. As will be seen in FIG. 15, the vendor's internet protocol address is also dialed or configured when the dynamic server name (DSN) (see 156) is available.

As a next step as indicated at 158 in FIG. 15, the database in the server 22 is configured to select the type of the local database as discussed above in connection with block 132 in FIG. 14. A signal is then provided on a line 159 in FIGS. 15 and 16. This causes the database in the server 22 to be configured (see 160 in FIG. 16) to submit the table name and password in accordance with 134 in FIG. 14. The table name and password are submitted in order to select the portion or table of the server 22 where the information relating to the inventory of the alternator at the vendor 16 is located. The selection of the portion or table of the server 22 storing the information relating to the alternator is indicated at 162 in FIG. 16. This information is saved (164). The next step of determining the specific rows in the table or portion in FIG. 14 for the storage of the information relating to the inventory of the alternator at the vendor is not shown in FIG. 16 since this step is performed at the purchaser's central office 10.

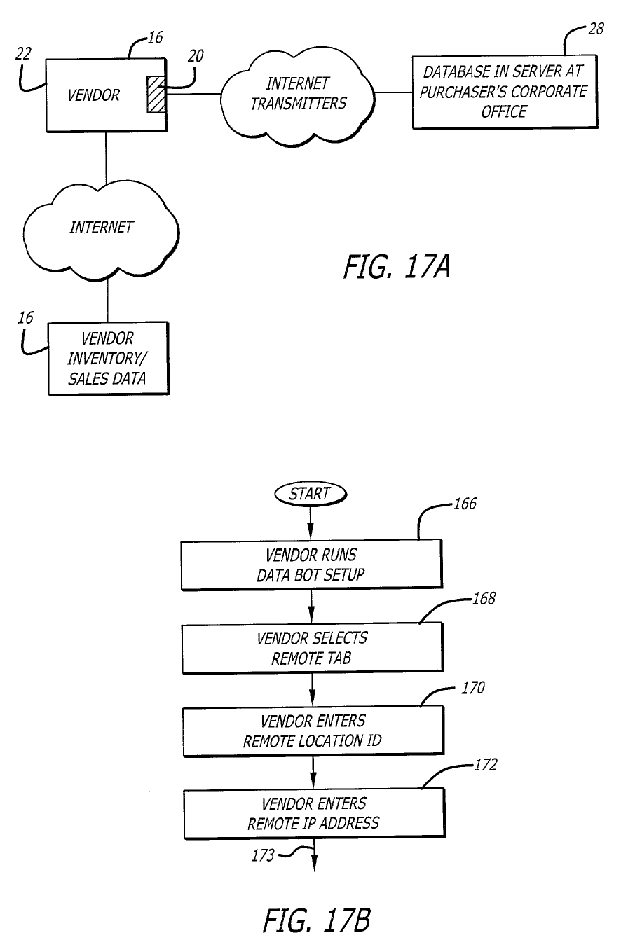

FIG. 17 constitutes a flow chart which is included in co-pending application Ser. No. 10/219,098 (attorneys file GCOMM-61556) and which further defines the relationship between the databot 20 at the vendor 16 and the database in the server 28 at the purchaser's corporate office 10. As a first step in FIG. 17, the vendor 16 provides information relating to the parameters shown in FIG. 14 and discussed above. These include (1) the internet protocol in the server 22 at the vendor, (2) the selection of the type (e.g. Oracle) of the database at the vendor, (3) the portion or table 134 of the database holding the information relating to the inventory of the alternator at the vendor and (4) the rows 136 specifically holding in the portion or table 134 the information relating to the inventory of the alternator at the database. This information is provided through the intranet to the databot 20 at the vendor 16. The information is then transmitted through the internet to the power site database 26 in the server 28 at the purchaser's corporate office 10. It will then be appreciated that the showing in FIG. 17 and in all of the previous drawings and the discussion in this paragraph, and in all of the previous paragraphs, apply equally as well to all of the different products supplied by the vendor 16 to the purchaser 12 as it does to the alternator specified in the previous discussion.

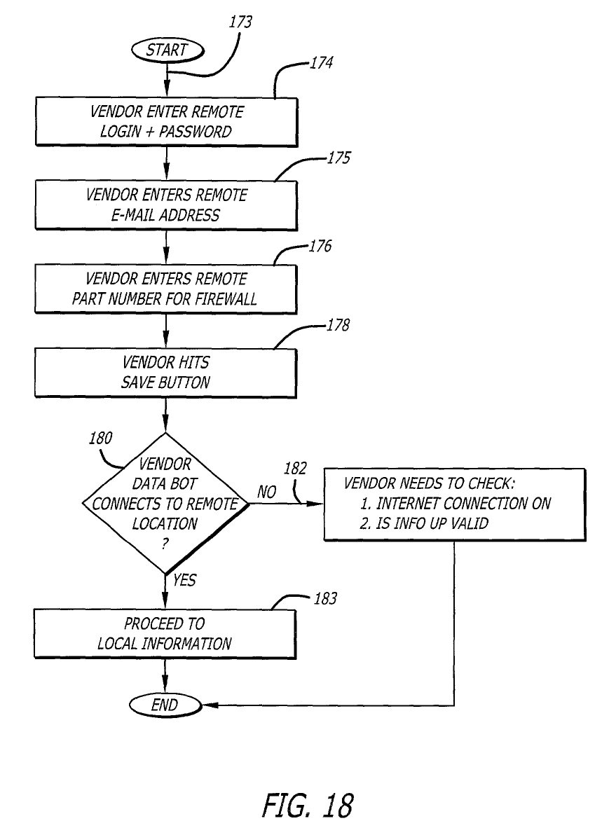

FIGS. 18a and 18b are included in co-pending application Ser. No. 10/219,098 (attorneys file GCOMM-61556) and provide a composite flow chart relating to the operation at the vendor 16 in providing to the purchaser's corporate office 10 the information specified in the previous paragraph. As a first step indicated at 166 in FIG. 18a, the vendor operates the databot 20 to select a remote tab indicating the identity of the purchaser's corporate office 10. The selection of the remote tab by the vendor 16 is indicated at 168. The vendor then enters the remote location identification (constituting the identification number) of the purchaser's corporate office 10 (see 170). The vendor subsequently enters the internet protocol address at the purchaser's corporate office 10. This is indicated at 172 in FIG. 18a. It corresponds to the location where the power site database 26 exists at the purchaser's corporate office 10. A line 173 extends from the bottom of FIG. 18a to the top of FIG. 18b to indicate that the flow chart continues in FIG. 18b.

The vendor 16 thereafter enters the remote login and password to provide for a transmission through the internet to the purchaser's corporate office 10 of the information relating to the inventory of the alternator at the vendor. This is indicated at 174 in FIG. 18b. As previously indicated, the login and password is to provide for the information to pass through the firewall established between the vendor 16 and the purchaser's central office 10. The firewall is provided to keep secure the information passing between the vendor 16 and the purchaser's corporate office 10.

The vendor then enters the remote e-mail address of the purchaser's corporate office (see 175). The vendor subsequently enters the remote port number for the firewall as indicated at 176. The vendor then hits the save button, as indicated at 178, to have the information saved. The vendor's databot then connects through the internet to the purchaser's corporate office 10 as indicated at 180. If the connection is not provided, the vendor may wish to check, as at 182, if the internet connection has been provided to the purchaser's corporate office 10 and if the information to be transmitted is valid. This information is shown in FIGS. 18a and 18b and in FIG. 14 and is discussed above. If the connection is provided, the information shown in FIG. 14 and the information shown in FIGS. 15 and 16 are transmitted by the vendor 16 to the purchaser's corporate office 10. This is indicated at 183 in FIG. 18b.

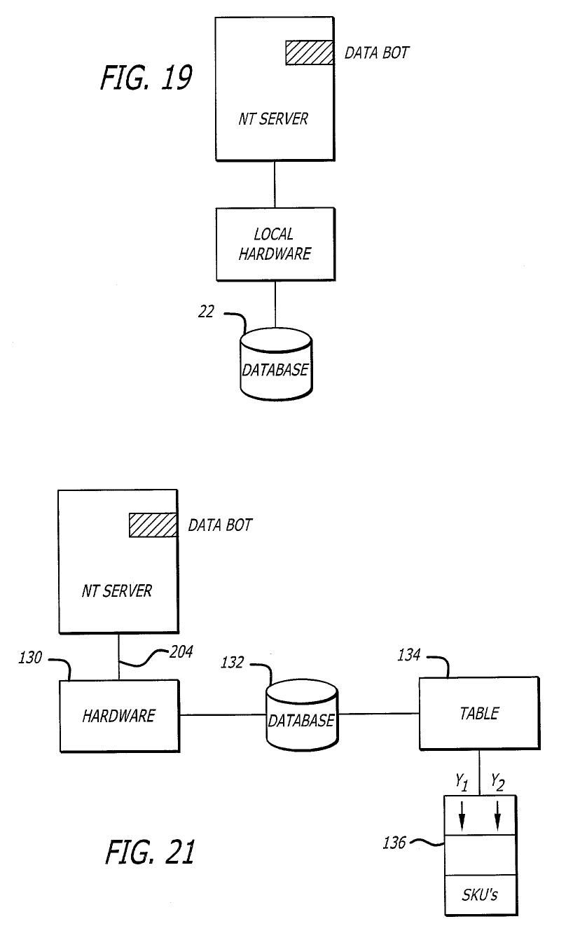

FIG. 19 is a flow chart included in co-pending application Ser. No. 10/219,098 (attorneys file GCOMM-61556) and shows the times at which the vendor 16 transmits to the purchaser's corporate office 10 the information relating to different products that the vendor sells to the purchaser's corporate office. The times for providing the transmission of this data from the vendor 16 to the purchaser's corporate office 10 are provided by rules established by the purchaser's corporate office to the vendor. A simple set of rules would specify that the vendor 16 sends to the purchaser's corporate office 10 in sequence indications of the inventory of each product sold by the vendor to the purchaser 12. For example, this transmission would be at spaced time intervals for all of the different products sold by the vendor to the purchaser. A more sophisticated set of rules would provide for the interval between successive transmissions relating to inventory to depend upon additional factors.

For example, one factor may be the volume at which the vendor 16 sells each individual product to the purchaser 12. For example, the vendor 16 may have to provide to the purchaser the indication of the inventory relating to a fast selling product more often than the inventory relating to a slow selling product. Another factor may be the price of the product. For example, the inventory relating to a high priced product may be transmitted by the vendor to the purchaser more often than the inventory of a product selling at a price less than a dollar. Still another factor may be seasonal. For example, the transmission to the purchaser 12 of information relating to the inventory of toys may occur more often during the Christmas season than at other times of the year. Similarly, the transmission of inventory to the purchaser 12 relating to swim suits may occur more often in the spring and summer than during the fall and winter.

FIG. 19 is included in co-pending application Ser. No. 10/219,098 (attorneys file GCOMM-61556) and shows that the server 22 database at the vendor 16 provides information relating to the inventory of a product such as the alternator to the databot 20 at the vendor. The vendor then transmits this information to the purchaser's corporate office 10. This information may include the interval (such as in hours and/or minutes) between successive transmissions. It may also include the time of the day, and the day(s) of the week, that the transmission occurs with respect to each individual product such as the alternator.

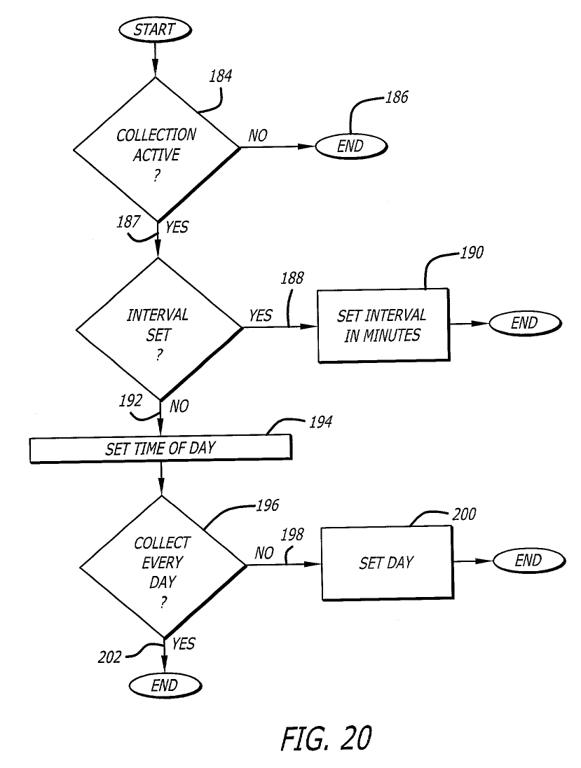

FIG. 20 is a flow chart included in co-pending application Ser. No. 10/219,098 (attorneys file GCOMM-61556) and shows how the vendor 16 responds to the rules established by the purchaser's corporate office 10 and transmitted by the purchaser to the vendor 16. As a first step 184 in the flow chart shown in FIG. 20, a determination is made as at 18a at the vendor 16 as to whether the vendor is collecting the rules from the purchaser's corporate office. If the answer is no (see 186), this is the end of the procedure shown in FIG. 20. If the answer is yes (187), a determination is made as to whether there is to be an interval between successive transmissions concerning the inventory of the alternator. If the answer is yes (188), the time interval is set (e.g. in minutes) as at 190. If the answer is no (192) to indicate that the time interval does not have to be set, the time of the day for indicating the inventory of the alternator is set. This is indicated at 194. An inquiry (196) is accordingly provided to indicate whether the data indicating the inventory of the alternator at the vendor 16 should be collected every day. If the answer is no (198), the day for collecting the data to indicate the inventory of the alternator at the vendor is set as indicated at 200. If the answer is yes as indicated at 202, the data is collected every day at the time set in the block 184.

FIG. 21 is a flow chart included in co-pending application Ser. No. 10/219,098 (attorneys file GCOMM-61556) and illustrates how different functions are performed at the vendor 16 in accordance with the operation of the databot 20 at the vendor. As a first step, the databot 20 is connected to a suitable data base such as the server 22. This is indicated at 204 in FIG. 21. In the next step, the vendor's internet protocol address is selected. This is also shown at 130 in FIG. 14. The type of the database (e.g. Oracle) is thereafter selected as also indicated at 132 in FIG. 14. A part or table of the database 134 is thereafter selected. This is also indicated at 134 in FIG. 14. As previously indicated, this part or table may be selected to provide a name and password for security purposes so that information can pass through the firewall between the vendor 16 and the purchaser's corporate office 10.

As a final step in FIG. 21, the row for the indication of the inventory of the alternator is then selected as also indicated at 136 in FIG. 14. Two (2) columns may be associated with each row. One column may indicate the inventory of the product such as the alternator. The other column shows the units of the alternator that have recently been dispensed since the last time that the inventory on the alternator has been transmitted by the vendor 16 to the purchaser's corporate office 10. It will be appreciated that the second (2d) column may indicate the dispensing of the alternator over a different period of time than the last report to the purchaser's corporate office 10 without departing from the scope of the invention.

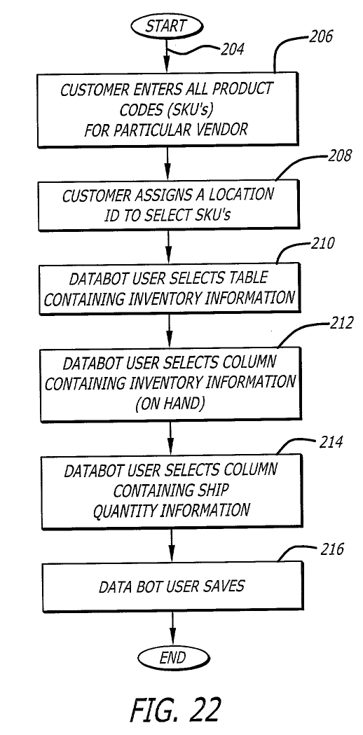

FIG. 22 is a flow chart included in co-pending application Ser. No. 10/219,098 (attorneys file GCOMM-61556) and indicates how the purchaser's corporate office 10 selects the location in the vendor's records of the different products (stock keeping units or “SKU's”) sold by the vendor 16 to the purchaser 12. As a first step indicated at 206, the purchaser 12 enters all of the different types of products (SKU's) which the vendor sells to the purchaser. The purchaser 12 then assigns a location, indicated at 208, in which the information relating to each individual one of the different products or SKU's is located. The purchaser then selects the portion or table (including the row) of the vendor's database 22 where the inventory information relating to the different products (SKU's) is located. This is indicated at 210 in FIG. 22.

The purchaser 12 thereafter selects the first column (see FIG. 21) where the inventory information relating to each individual product (e.g. the alternator) is located. (See 212). The purchaser thereafter selects the second column (see FIG. 21) which contains the information relating to the amount of the inventory shipped by the vendor 16 to its customers since the previous recording period. This is indicated at 214. As a final step indicated at 216 in the flow chart in FIG. 21, the purchaser saves the information specified in FIG. 21. It will be appreciated that the vendor 16 may save similar information in the databot 20.

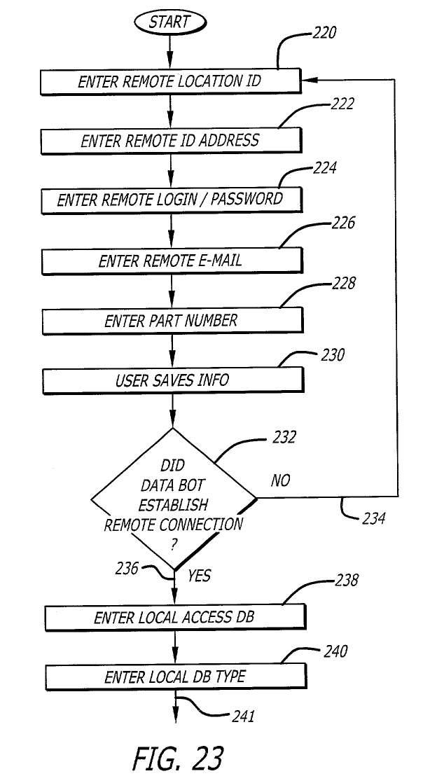

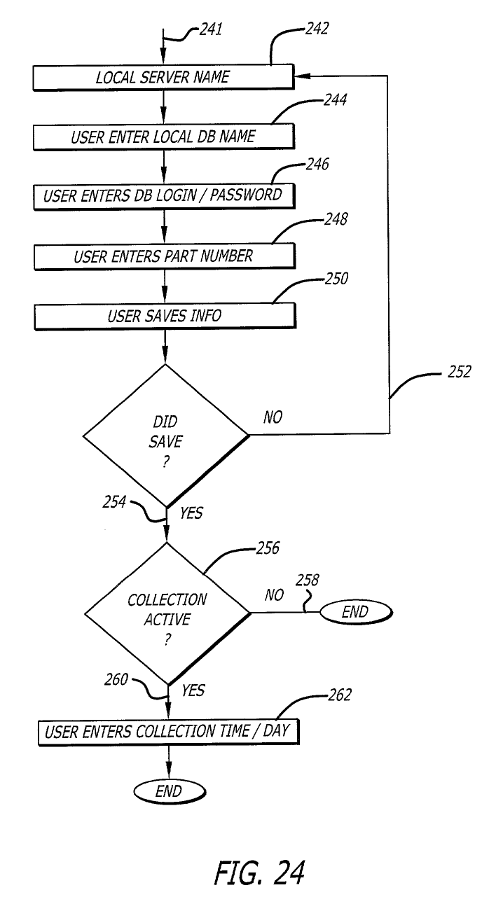

FIGS. 23 and 24 are included in co-pending application Ser. No. 10/219,098 (attorneys file GCOMM-61556). FIGS. 23 and 24 constitute a composite flow chart indicating the operation of the vendor 16 in entering information controlling how they communicate with each other through the internet. As a first step indicated at 220 in FIG. 23, the vendor 16 enters the remote identification of the purchaser 12. As a next step (see 222), the vendor 16 enters the remote internet protocol address of the purchaser 12. The vendor 16 then enters the remote login and password to overcome the security barrier between the vendor and the purchaser to provide for the communication between the vendor and the purchaser through the firewall. This is indicated at 224 in FIG. 23.

As a next step as indicated at 226, the vendor 16 enters the remote e-mail address of the purchaser's corporate office 10. The vendor then enters the part number of the product (e.g. the alternator). See 228. The vendor may save the information. This is indicated at 230. The vendor thereafter asks (232) if the databot 20 at the vendor has established a remote connection with the purchaser's corporate office 10 through the internet. If the answer is no (234), the vendor 16 starts the process again as indicated at 220.

If the databot 20 at the vendor has established a communication with the purchaser's central office 10 through the internet, such an indication is provided at 236. The purchaser's corporate office 10 then enters the power site database 26 (see 238) and the purchaser's office enters the type of the local database (see 240). As shown in FIG. 24, the purchaser's central office 10 then enters the name (242) of the local server and the local database name (244). The purchaser's central office enters the database login and password (246) to provide a communication through the firewall between the vendor 16 and the purchaser's corporate office 10. The purchaser's corporate office 10 thereafter enters the part number (248) of the product such as the alternator.

The purchaser's corporate office 10 may then decide to save the information as indicated at 250. If the information is not saved (see 252), the process is repeated starting with the step 242. If the information is saved (see 254), a decision is made as to whether the vendor should start to send data to the purchaser's corporate office. If the answer is no (see 258), this is the end of the successive steps shown in FIGS. 23 and 24. If the answer is yes as indicated at 260, the purchaser's corporate office 10 enters the day, and the time of the day, that the collection of the data is initiated. See 262.

As shown in the drawings and disclosed in detail in the specification, a system is provided in which the purchaser's corporate office 10 receives information from the vendor 16 concerning the inventories at the vendor of the product (e.g. the alternator) supplied by the vendor to the purchaser. This information is provided by the vendor 16 to the purchaser 14 periodically in accordance with rules established by the purchaser and transmitted by the purchaser to the vendor. One purpose of this arrangement is to provide the purchaser 14 with an opportunity to quickly obtain units of a product from the vendor when the purchaser is in short supply of the product.

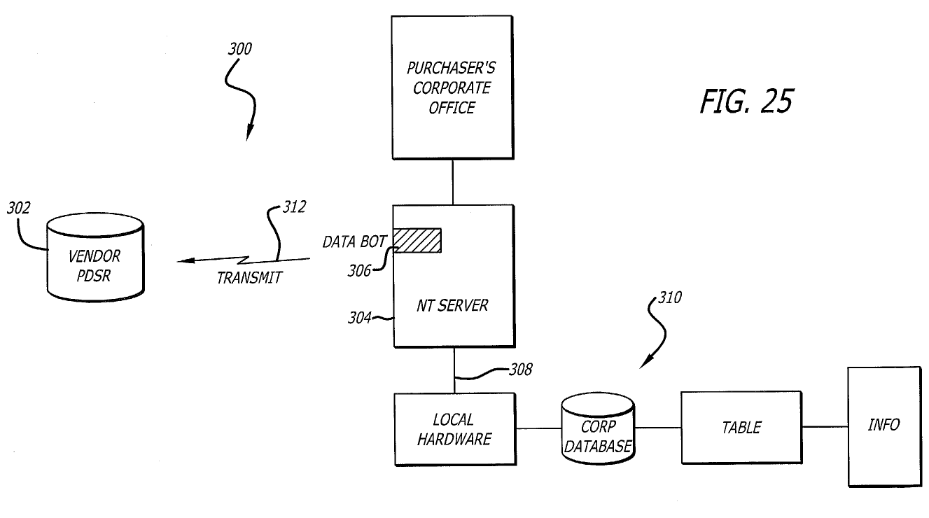

FIG. 25 schematically shows a preferred embodiment, generally indicated at 300, which is disclosed and claimed in co-pending application Ser. No. 10/219,098 (attorneys file GCOMM-61556) and which is similar in many ways to the preferred embodiment shown in FIGS. 1-24 and described above. However, in many ways the roles of the vendor and the purchaser are reversed in the sense of who makes the inquiries concerning inventory of products and who provides the information relating to inventory of products. In the system shown in FIG. 25, the vendor 16 inquires of the purchaser's corporate office 10 concerning the inventory which the purchaser has at any instant of a product such as the alternator. The purpose of the inquiry is for the vendor to suggest to the purchaser 14 that the purchaser may wish to order additional units of a product such as the alternator when the purchaser's inventory of the product has dwindled to a relatively low level.

FIG. 25 shows a power site data base 302 at the vendor similar to the power site database 26 at the purchaser's corporate office 10 in the preferred embodiment shown in FIGS. 1-24. FIG. 25 also includes a server 304 at the purchaser 12 similar to the server 22 at the vendor 16 in the embodiment shown in FIGS. 1-24. FIG. 25 additionally shows a databot 306 at the purchaser's corporate office 10 similar to the databot 20 at the vendor 16 in the embodiment shown in FIGS. 1-24.

As a first step as indicated at 308 in FIG. 25, the purchaser's corporate office 10 loads the databot 306 in the server 304 so that the databot and the server provide a record of inventory at the purchaser of the different products supplied by the vendor to the purchaser. In the next step indicated at 310 in FIG. 25, the purchaser's corporate office 10 runs the remote set up of the databot 306 to identify hardware, data and tables similar to those indicated at 130, 132, 134 and 136 in FIG. 14.

The purchaser's corporate office 10 then operates the databot 300 on a local basis to establish a connection to the vendor 16 in a manner similar to the operation of the databot 20 on a local basis as shown in FIGS. 23 and 24 to establish a connection between the vendor and the purchaser's corporate office 10. See 312 in FIG. 25. As a final step, the databot 306 at the purchaser's corporate office 10 transmits inventory and data to the vendor to indicate to the vendor inventory levels of the different products at the purchaser 12.

The transmission of the inventory levels from the purchaser's corporate office 10 to the vendor 16 may be in accordance with established rules specifying the times for such transmissions controlling the operation of the purchaser's corporate office 10. These rules are probably established preferentially by the purchaser's corporate office 10 to provide a safeguard to the purchaser to make certain that the purchaser always has sufficient inventories of products supplied by the vendor to the purchaser 12. However, the rules may also be established by the vendor 16 to provide a safeguard to the vendor for assuring that the purchaser 12 is always happy with its relationship with the vendor.

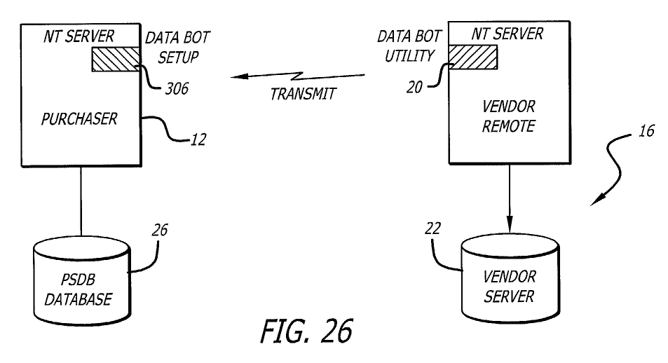

FIG. 26 shows an improved system for enhancing the speed of operation of the system shown in FIGS. 1-25 and described above. In the system shown in FIG. 26, the power site database 26 at the purchaser 12 provides a sequence of rules to the databot 306 at the purchaser. The power site database 26 then transfers the rules in the sequence to the databot 306 at the purchaser 12 and the databot transmits the rules to the databot 20 at the vendor 16. While the databot 306 is receiving each rule in the sequence from the power site database 26, the databot is transmitting the previous rule in the sequence to the vendor 16. In this way, the speed of transmitting the rules from the purchaser 12 to the vendor 16 is enhanced.

The system at the vendor 16 operates in the same way as the system at the purchaser 12. The server 22 at the vendor 16 transfers transaction data in a sequence to the databot 20 at the vendor 16 and the databot transmits this data to the purchaser 12. While the databot 20 is receiving the transaction data relating to each transaction in the sequence from the server 20, the databot is transmitting to the purchaser 12 the transaction data relating to the previous transaction in the sequence. This enhances the speed of transmitting the transaction data in the sequence to the purchaser 12.

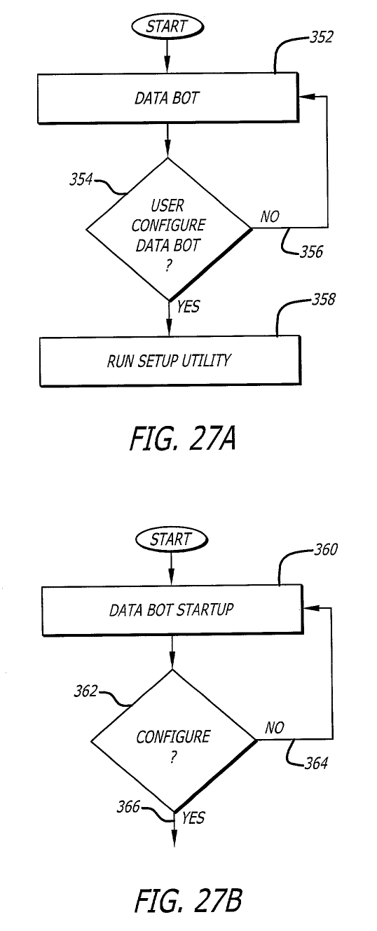

FIG. 27 provides flow charts indicating how the system at the purchaser 12 is constantly alerted to transmit rules to the vendor 16 and how the vendor is constantly alerted to transmit transaction data (e.g. product inventory) to the purchaser. This constant state of alertness at the purchaser 12 and the vendor 16 simplifies and enhances the operation of the system. As a first step at the purchaser 12, the databot 306 is activated as at 352. A determination is then made (as at 354) as to whether the databot 20 has been configured to indicate the type of database 132 (FIG. 14) being used and to select the portion or table 134 of the database where the transaction data of the transaction is located.

If the determination is made that the databot 306 has not been configured, the databot is reactivated as at 356 to obtain a new determination of configuration. If the determination is made that the databot 306 has been configured, the rules relating to the date and time for the transmission of transaction data (e.g. product inventory) from the vendor 16 to the purchaser 12 are transmitted to the purchaser 12. This is indicated at 358 in FIG. 27.

A similar arrangement to that described in the previous paragraph is provided at the vendor 16. The databot 20 is initially activated as at 360. A determination (362) is then made as to whether the databot 20 has been configured to select the type of database and to select the portion or table in which the transaction data is located. If the answer is no (364), the databot 20 is reactivated. If the answer is yes (366), the databot transmits the transaction data relating to the transactions (e.g. product inventory) to the purchaser 12.

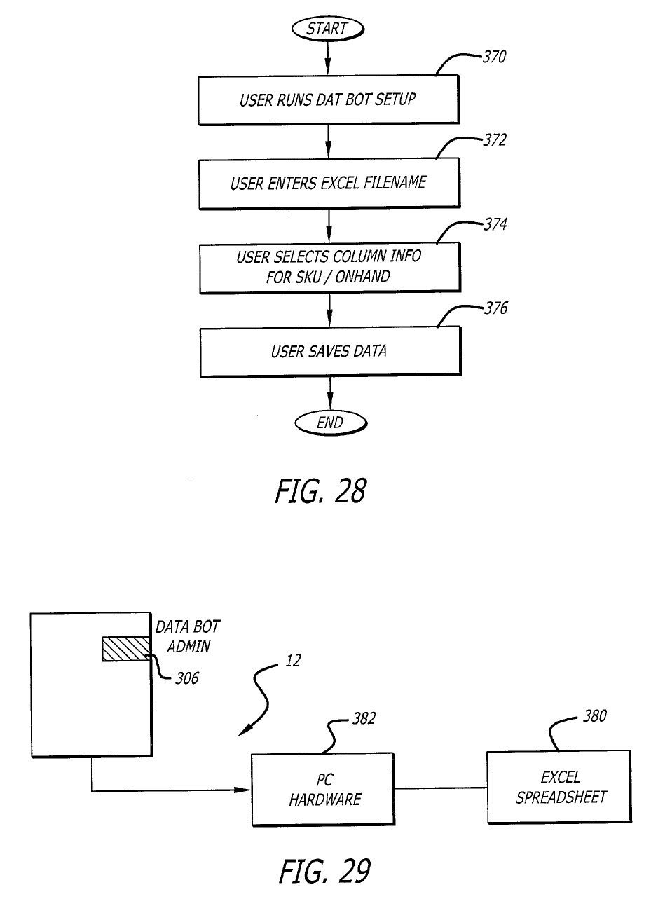

In the systems shown in FIGS. 1-27 and described above, the purchaser 12 obtains information from the power site database 26 to transmit transaction data relating to transactions. FIG. 28 provides a flow chart in which a spreadsheet such as an Excel spreadsheet is used instead of the database 26 to transmit to the vendor 16 rules relating to transactions (e.g. product inventory).

As a first step 370 in the flow chart in FIG. 28, the databot 306 at the purchaser 12 is set up to transmit rules to the purchaser 12. Setting up a databot such as the databot 306 is shown in FIG. 21 and has been described in detail above. The user then enters the spreadsheet such as the Excel spreadsheet. This is indicated at 372 in FIG. 28. The user then selects the column in the spreadsheet for the stock keeping unit whose rules relating to date and time are to be transmitted to the vendor 12. See 374. The user then saves this data as indicated at 376.

It will be appreciated that a flow chart similar to that shown in FIG. 28 may be provided at the vendor 16. In this way, a spreadsheet can be provided at the vendor 16 to control the transmission of transaction data relating to transactions (e.g. product inventory) to the purchaser 12.

FIG. 29 is a simplified schematic diagram of the system for transmitting the spreadsheet data to the vendor 16. In FIG. 29, the spreadsheet is indicated at 380. The spreadsheet data is introduced to personal computer hardware 382 which processes this data. The processed data is then introduced to the databot 306 at the purchaser 12 for transmission to the vendor 16.

Although this invention has been disclosed and illustrated with reference to particular embodiments, the principles involved are susceptible for use in numerous other embodiments which will be apparent to persons of ordinary skill in the art. The invention is, therefore, to be limited only as indicated by the scope of the claims.

What is claimed is:

1. In a method of providing to a first party an indication of transactions represented by transaction data at a second party displaced from the first party, the steps of:
providing a databot at the first party,
providing, from a power site database at the first party to the databot at the first party, rules relating to the transmission of information from the second party to the first party concerning the transactions represented by the transaction data at the second party, and
simultaneously providing to the databot at the second party from the databot at the first party the rules previously provided by the power site database at the first party to the databot at the first party to the databot at the first party.

2. In a method as set forth in claim 1, the step of:
transferring from the second party to the first party, in accordance with the rules provided by the first party to the second party, information relating to the transactions represented by the transaction data at the second party.

3. A method as set forth in claim 1 wherein
the first party is a seller who purchases the transactions represented by the transaction data from the second party and the second party is a vendor who sells the transactions represented by the transaction data to the first party and the provision of information relating to the transactions represented by the transaction data from the second party to the first party is to enable the first party to transfer the transactions represented by the transaction data to a customer of the first party.

4. In a method as set forth in claim 1 wherein
the transactions relate to inventory of a product and the transaction data relate to the acquisition and sale of units of the product by the second party.

5. Apparatus as set forth in claim 1 wherein
the rules relate to the dates and times selected by the first party when the second party is to transmit to the first party the transactions represented by the transaction data.

6. In a method as set forth in claim 3 wherein
the rules relate to the dates and times selected by the first party when the second party is to transmit to the first party the transactions represented by the transaction data.

7. In a method of providing to a first party an indication of transactions represented by transaction data at a second party, the steps of:
providing a databot at the first party,
providing a databot at the second party,
providing, from a server at the second party to the databot at the second party, transactions represented by transaction data at the second party for transmission to the databot at the first party, the transactions represented by the transaction data being provided at the second party in accordance with rules established by the first party and provided to the second party, and
simultaneously providing to the databot at the first party from the databot at the second party the transactions represented by the transaction data previously provided by the server at the first party to the databot at the second party.

8. In a method as set forth in claim 7, the step of:
transferring from the first party to the second party the rules provided by the first party for controlling the transfer from the databot at the second party to the databot at the first party of the transactions represented by the transaction data.

9. In a method as set forth in claim 7 wherein
the transactions relate to inventory of a product and the transaction data relate to the acquisition and dispensing of units of the product by the second party.

10. In a method as set forth in claim 7 wherein
the rules relate to the dates and times selected by the first party when the second party is to transmit to the first party the transactions represented by the transaction data at the second party.

11. In a method as set forth in claim 7 wherein
the rules relate to the dates and times selected by the first party when the second party is to transmit to the first party the transactions represented by the transaction data and wherein
the rules provided by the first party are transferred to the second party for controlling the transfer from the databot at the second party to the databot at the first party of the transactions represented by the transaction data.

12. In a method of providing to a first party an indication of transactions represented by transaction data at a second party displaced from the first party, the steps of:
providing a databot at the second party,
providing a programming from the first party to the databot at the second party to have the second party specify to the first party, at particular times specified by the first party, the transactions represented by the transaction data at the second party,
providing a server at the second party,
providing a transfer in sequence to the databot at the second party of the transactions represented by transaction data at the second party, and
providing a transmission by the databot at the second party of the transaction data relating to the transactions in the sequence on the basis that the databot transmits the transaction data for each transaction in the sequence while the server is transferring to the databot the transaction data relating to the next transaction in the sequence.

13. In a method as set forth in claim 12 wherein
the first party establishes rules relating to the times at which the transaction data relating to the transactions at the second party are to be transferred to the first party and wherein
the first party transmits these rules to the databot at the second party.

14. In a method as set forth in claim 12 wherein
the transaction data relates to inventory held by the second party of products sold by the second party to the first party.

15. In a method as set forth in claim 12 wherein
the second party is one of a vendor or a customer of the vendor and the first party is the other one of the vendor and the customer of the vendor.

16. In a method as set forth in claim 12 wherein
the transaction data relates to inventory held by the second party of products sold by the second party to the first party and wherein
the second party is one of a vendor or a customer of the vendor and the first party is the other one of the vendor and the customer of the vendor.

17. In a method of providing to a first party an indication of transactions represented by transaction data at a second party displaced from the first party, the steps of:
providing a databot at the first party,
providing a power site database at the first party,
providing at the power site database a sequence of rules relating to the times at which the second party is to transmit transaction data representing transactions in the sequence at the second party,
providing a transfer in sequence to the databot at the second party of the rules provided at the power site database, and
providing a transmission to the databot of the rules in the sequence on the basis that the databot transmits each rule in the sequence while the power site database is transferring to the databot the next rule in the sequence.

18. In a method as set forth in claim 17 wherein
the second party transmits to the first party the transaction data representing the transactions in accordance with the rules transmitted by the first party to the second party.

19. In a method as set forth in claim 17 wherein
the transaction data relates to inventory held by the second party of products sold by the second party to the first party.

20. In a method as set forth in claim 17 wherein
the second party is one of a vendor or a customer of the vendor and the first party is the other one of the vendor and the customer of the vendor.

21. In a method as set forth in claim 17 wherein
the transaction data relates to inventory held by the second party of products sold by the second party to the first party and wherein
the second party is one of a vendor or a customer of the vendor and the first party is the other one of the vendor and customer of the vendor.

22. In a method as set forth in claim 17, including the steps of:
providing a databot at the second party,
providing a server at the second party,
providing a transfer in sequence to the databot at the second party of the transactions represented at the second party to the databot at the second by the transaction data, and
providing a transmission by the databot at the second party of the transaction data relating to the transactions in the sequence on the basis that the databot transmits the transaction data for each transaction in the sequence while the server is transferring to the databot at the second party the transaction data relating to the next transaction in the sequence.

23. In a method of providing to a first party an indication of transactions represented by transaction data at a second party displaced from the first party, the steps of:
activating a databot at the first party,
determining whether the user has configured the databot to transmit to the second party information relating to transactions represented by the transaction data at the first party,
reactivating the databot if the determination indicates that the user has not configured the databot, and
setting up the databot to transmit to the second party the transaction data representing the transactions when the user has configured the databot.

24. In a method as set forth in claim 23 wherein
the step of setting up includes the steps of selecting a type of database where the transaction data is to be recorded and selecting the location of the transaction data in a particular portion of the database.

25. In a method as set forth in claim 23, including the step of:
transmitting to the second party the transaction data representing the transactions when the databot has been set up.

26. In a method as set forth in claim 24, including the steps of:
transmitting to the first party the transaction data representing the transactions and provided in the location selected in the particular portion of the database.

27. In a method of providing to a first party an indication of transactions represented by transaction data at a second party displaced from the first party, the steps of:
activating a databot at the second party,
determining whether the user has configured the databot to transmit to the first party information relating to transactions represented by the transaction data at the second party,
reactivating the databot if the determination indicates that the user has not configured the databot, and
setting up the databot to transmit to the first party the transaction data representing the transactions when the user has configured the databot.

28. In a method as set forth in claim 27 wherein
the step of setting up includes the steps of selecting a type of database compatible with a database at the first party and selecting a particular portion of the database where the transaction data is to be recorded and selecting the location of the transaction data in the particular portion of the database.

29. In a method as set forth in claim 27, including the step of:
transmitting to the first party the transaction data representing the transactions when the databot has been set up.

30. In a method of providing to a first party an indication of transactions represented by transaction data at a second party displaced from the first party, the steps of:
providing a databot at the first party,
providing rules to the databot at the first party from a spreadsheet relating to the times for the transmittal by the second party of transactions represented by the transaction data at the second party, and
introducing the rules to the databot for transmission to the second party.

31. In a method as set forth in claim 30, including the step of:
transmitting the rules from the databot at the first party to the second party.

32. In a method as set forth in claim 30 wherein
the rules specify the transactions to be reported by the second party to the first party and wherein
the rules further relate to the dates and times for the second party to transmit to the first party the transaction data relating to the transactions specified in the rules.

33. In a method as set forth in claim 30 wherein
the transactions relate to products sold by the second party to the first party and wherein the transaction data relate to the inventory of these products.

34. In a method as set forth in claim 33 wherein
the rules are transmitted from the first party to the second party and wherein
the rules specify the transactions to be reported by the second party to the first party and wherein
the rules further relate to the dates and times for the second party to transmit to the first party the transaction data relating to the transactions specified in the rules.
